(19) United States
(12) Patent Application Publication
(10) Pub. No.: US 2021/0138749 A1
(43) Pub. Date: May 13, 2021

(54) TIRE FORMING APPARATUS AND TIRE MANUFACTURING METHOD

(71) Applicant: BRIDGESTONE CORPORATION, Tokyo (JP)

(72) Inventor: Satoshi IYANAGI, Kodaira-shi, Tokyo (JP)

(73) Assignee: BRIDGESTONE CORPORATION, Tokyo (JP)

(21) Appl. No.: 16/623,583

(22) PCT Filed: Apr. 25, 2018
(86) PCT No.: PCT/JP2018/016804

§ 371 Date: Dec. 17, 2019

(30) Foreign Application Priority Data
Jun. 19, 2017 (JP) 2017-120007

(51) Int. Cl. B29D 30/32; B29D 30/26

(52) U.S. Cl. CPC B29D 30/32; B29D 2030/3264; B29D 30/26

(57) ABSTRACT

A tire forming apparatus including: a drum spindle body; a plurality of arms arranged in annular shape on an outer circumferential side of the drum spindle body; and pushing means configured to push the arms in a direction approaching an unvulcanized tire member, along an extending direction of the drum spindle body, wherein each arm includes: a slidable contact portion provided on one end side of the arm and configured to slidably contact the pushing means; a press portion provided on the other end side of the arm and configured to contact the unvulcanized tire member and press the unvulcanized tire member; and a connecting portion provided between the slidable contact portion and the press portion in the arm extending direction and connected to the drum spindle body, on the drum spindle body side with respect to a line segment connecting the slidable contact portion and the press portion.

### TECHNICAL FIELD

The present disclosure relates to a tire forming apparatus and a tire manufacturing method.

### BACKGROUND

In the manufacturing of a tire, there is a tire-member folding back step in which, on a forming drum, a tire member, such as an unvulcanized carcass ply, is folded back around a bead core from inside to outside in a radial direction of the drum.

Conventionally, in the tire-member folding back step, a tire forming apparatus 300 may be used, the tire forming apparatus 300 including a drum spindle body 31, a plurality of arms 32 arranged in an annular shape on an outer circumferential side of the drum spindle body 31 (one of the plurality of arms 32 is illustrated in FIG. 4), a spring member such as a rubber band 35 that bundles the arms 32, and arbitrary pushing means 33 that pushes the arms 32 in a direction approaching the tire member, along an axial direction of the drum spindle body 31 as illustrated in FIG. 4 depicting a part of the conventional tire forming apparatus 300.

In the tire forming apparatus 300, when the arm 32 is pushed in the axial direction of the drum spindle body 31 by the pushing means 33 and a front end portion 32A of the arm 32 is pushed against a carcass ply 30 around a bead core (not illustrated) (the state indicated with the solid line in FIG. 4), the arm 32 is moved about a rear end portion 32B of the arm 32 as a fulcrum and opened outward in a radial direction of the drum spindle body 31 while pressing the carcass ply 30 (the state indicated with the broken line in FIG. 4).

At this time, in addition to a press force resulting from a pushing force N from the pushing means 33, a press force resulting from a biasing force T (indicated with a spring symbol in the drawing) due to tension of the rubber band 35 is applied to the carcass ply 30 through the front end portion 32A of the arm 32 (a press force F in the drawing). Since the biasing force T due to tension of the rubber band 35 increases with the opening movement of the arm 32, the press force F to be applied to the carcass ply 30 increases in proportion to an inclination angle θ of the arm 32 (hereinafter referred to as the “arm angle θ”) with respect to the axial direction of the drum spindle body 31.

That is, when the arm 32 pushes an outer zone in the radial direction of the drum spindle body 31 relative to the vicinity of the bead core (for example, the arm angle θ is 30°) as indicated with the two-dot chain line in FIG. 4, the press force F is larger compared to the press force F, indicated with the solid line in FIG. 4, when the arm 32 pushes the vicinity of the bead core (for example, the arm angle θ is 0°).

Specifically, as indicated in the graph of FIG. 5, for example, the press force F when the arm angle θ is 30° is more than twice the press force F when the arm angle θ is 0°.

In the conventional tire forming apparatus 300, the press force F changes with the opening movement of the arm 32 as described above, and therefore the press force may be insufficient in the vicinity of the bead core and the air may enter between the bead core and the carcass ply 30, and, in some cases, the press force became excessive in the outer zone in the radial direction of the drum spindle body 31 relative to the vicinity of the bead core and caused unevenness defects such as an imprint remaining on an attachment surface of the carcass ply 30.

In order to reduce such folding back defects of the unvulcanized tire member, for example. PTL 1 discloses a technique of arbitrarily adjusting a press force to be applied to a carcass ply by an arm with the use of a carcass ply folding back device having storage means that stores a movement path of a press member capable of applying a predetermined press force, and a controller that controls the movement of the press member according to the movement path stored in the storage means.

### CITATION LIST

### Patent Literature

PTL 1: Japanese Patent Application Laid-Open No. 2014-177108

### SUMMARY

### Technical Problem

However, there is a demand for adjusting the press force with respect to the unvulcanized tire member according to a tire position by simpler means, and thereby reducing folding back defects of the tire member.

Hence, it is an object of the present disclosure to provide a tire forming apparatus and a tire manufacturing method that are capable of reducing folding back defects of an unvulcanized tire member by simple means.

### Solution to Problem

In order to solve the above problem, a tire forming apparatus of the present disclosure includes: a drum spindle body; a plurality of arms arranged in an annular shape on an outer circumferential side of the drum spindle body; and pushing means configured to push the arms in a direction approaching an unvulcanized tire member, along an axial direction of the drum spindle body, wherein each of the arms includes: a slidable contact portion provided on one end side of the arm and configured to slidably contact the pushing means; a press portion provided on an other end side of the arm and configured to come into contact with the unvulcanized tire member and press the unvulcanized tire member; and a connecting portion provided between the slidable contact portion and the press portion in an extending direction of the arm and connected to the drum spindle body, on the drum spindle body side with respect to a line segment connecting the slidable contact portion and the press portion.

According to this configuration, folding back defects of the unvulcanized tire member can be reduced by simple means.

In the present description, the “drum spindle body” means a component member that is a counterpart of relative movement of the arm along the axial direction. Hence, the “drum spindle body” includes not only a so-called drum spindle in the tire forming apparatus, but also other component members such as, for example, a bead lock mechanism, provided on the outer circumferential side of the drum spindle.

The “connecting portion connected to the drum spindle body” includes, of course, the case where the connecting portion is directly connected to the drum spindle body, and also includes the case where the connecting portion is indirectly connected to the drum spindle body through other component member.

Furthermore, in the present description, the “extending direction of the arm” refers to a direction along a line segment connecting the slidable contact portion and the press portion of the arm.

### Advantageous Effect

According to the present disclosure, it is possible to provide a tire forming apparatus and a tire manufacturing method that are capable of reducing folding back defects of an unvulcanized tire member by simple means.

### BRIEF DESCRIPTION OF THE DRAWINGS

In the accompanying drawings:

FIG. 1A is a schematic diagram depicting a part of a tire forming apparatus according to one embodiment of the present disclosure, and a view illustrating a state in which the arm angle θ is 0°;

FIG. 1B is a schematic diagram depicting a part of the tire forming apparatus according to one embodiment of the present disclosure, and a view illustrating a state in which the arm angle θ is 30°;

FIG. 2 is a graph indicating the press force of the tire forming apparatus of FIG. 1;

FIG. 3A is a schematic diagram depicting a part of a tire forming apparatus according to another embodiment of the present disclosure, and a view illustrating a state in which the arm angle θ is 0°;

FIG. 3B is a schematic diagram depicting a part of the tire forming apparatus according to another embodiment of the present disclosure, and a view illustrating a state in which the arm angle θ is 30°;

FIG. 4 is a schematic diagram depicting a part of a conventional tire forming apparatus, and a view illustrating a state in which the arm angle θ is 0°, with the solid line, and a state in which the arm angle θ is 30°, with the two-dot chain line; and

FIG. 5 is a graph indicating the press force of the tire forming apparatus of FIG. 4.

### DETAILED DESCRIPTION

Hereinafter, an embodiment of a tire according to the present disclosure will be described with reference to the drawings.

As illustrated in FIG. 1A, a tire forming apparatus 100 according to the present embodiment includes: a drum spindle body 1; a plurality of arms 2 arranged, at approximately equal intervals in the present embodiment though not illustrated, in an annular shape on an outer circumferential side of the drum spindle body 1; and pushing means 3 that presses the plurality of arms 2 in a direction approaching an unvulcanized tire member (an unvulcanized tire carcass ply 10 in the present embodiment) along an axial direction of the drum spindle body 1. Here, for the purpose of explanation, structures of one of the plurality of arms 2 and the vicinity are illustrated.

The arm 2 is arranged between the unvulcanized carcass ply 10 and the pushing means 3 in the axial direction of the drum spindle body 1. The arm 2 includes: a slidable contact portion 2A which is provided on one end side of the arm 2 and slidably contacts the pushing means 3; a press portion 2B which is provided on the other end side of the arm 2, and comes into contact with the carcass ply 10 and presses the carcass ply 10; and a connecting portion 2C which is in between the slidable contact portion 2A and the press portion 2B in an extending direction of the arm 2 and is connected to the drum spindle body 1, on the drum spindle body 1 side with respect to a line segment connecting the slidable contact portion 2A and the press portion 2B.

The arm 2 in the present embodiment has an arm main body portion 21 that couples the slidable contact portion 2A and the press portion 2B together, and an arm branch portion 22 that couples the arm main body portion 21 and the connecting portion 2C together, both of the arm main body portion 21 and the arm branch portion 22 extending linearly. The arm 2 as a whole is formed integrally so that the arm branch portion 22 is orthogonal to the arm main body portion 21.

The pushing means 3 in the present embodiment includes, for example, a driving source 3A such as a motor and a cylinder, and a pushing portion 3B which has a corresponding slidable contact surface S to be subject to slide contact with arm 2, and is to be biased in the axial direction of the drum spindle body 1 by the driving source 3A.

In the present embodiment, a plurality of pushing means 3 corresponding to the arms 2, respectively, are arranged, but the pushing means 3 may be configured to be capable of pushing all together the plurality of arms 2 arranged in an annular shape.

In the above-described configuration, when the arm 2 is pushed by the pushing means 3 in the axial direction of the drum spindle body 1, at the position of the slidable contact portion 2A provided on one end side of the arm 2, and then the press portion 2B provided on the other end side of the arm 2 is pushed against the carcass ply 10 in the vicinity of a bead core (the state illustrated in FIG. 1A), the arm 2 is moved about the connecting portion 2C as a fulcrum and opened outward in a radial direction of the drum spindle body 1 due to moment toward the outside in the radial direction of the drum spindle body 1 while pressing the carcass ply 10 (the state illustrated in FIG. 1B). That is, in the arm 2, the slidable contact portion 2A approaches the drum spindle body 1, on one side in the axial direction of the drum spindle body 1, through the connecting portion 2C serving as a fulcrum, and the press portion 2B is moved and opened to be distant from the drum spindle body 1 on the other side in the axial direction of the drum spindle body 1.

At this time, the slidable contact portion 2A of the arm 2 moves in a sliding contact manner on the corresponding slidable contact surface S′ of the pushing means 3 (the pushing portion 3B of the pushing means 3 in the present embodiment) from the outside to the inside in the radial direction of the drum spindle body 1 while receiving a pushing force N in the axial direction of the drum spindle body 1 from the pushing means 3 (a counter force from the pushing portion 38 of the pushing means 3 in the present embodiment). That is, during the opening movement of the arm main body portion 21, the slidable contact portion 2A moves relative to the pushing means 3 while being in contact with the corresponding slidable contact surface S′ of the pushing means 3.

Also, at this time, the press portion 2B of the arm 2 moves on the carcass ply 10 from the inside to the outside in the radial direction of the drum spindle body 1 while pressing the carcass ply 10 with a press force F in a direction perpendicular to an extending direction of the carcass ply 10, and folds back and crimps the carcass ply 10.

Furthermore, at this time, the connecting portion 2C of the arm 2 moves in a sliding contact manner, on the drum spindle body 1 in the present embodiment, along the axial direction of the drum spindle body 1 due to the pushing force N in the axial direction of the drum spindle body 1 from the pushing means 3. That is, during the opening movement of the arm main body portion 21, the connecting portion 2C moves relative to the drum spindle body 1 while being in contact with the drum spindle body 1 in the present embodiment.

As described above, the arm 2 in the present embodiment is moved and opened by receiving the moment toward the outside in the radial direction of the drum spindle body 1, but the slidable contact portion 2A, the press portion 2B and the connecting portion 2C of the arm 2 have the above-described positional relationship and the slidable contact portion 2A moves in a sliding contact manner on the corresponding slidable contact surface S′ of the pushing means 3 from the outside to the inside in the radial direction of the drum spindle body 1, and, therefore, when the arm angle θ increases with the opening movement of the arm 2, the pushing force N applied along the axial direction of the drum spindle body 1 has a larger component in a direction perpendicular to the extending direction of the arm main body portion 21 (in an extending direction of the arm branch portion 22 in the present embodiment). As a result, the press force F resulting from the component (and gravity (not illustrated) applied to the arm 2) decreases.

Thus, in the tire forming apparatus 100 according to the present embodiment, as indicated in the graph of FIG. 2, the press force F decreases as the arm angle θ increases. Specifically, for example, the press force F when the arm angle θ is 30° is about 60% of the press force F when the arm angle θ is 0°. Hence, in the tire forming apparatus 100, the press force F with respect to the unvulcanized carcass ply 10 can be suitably increased or decreased, according to the arm angle 9, based on a constant pushing force N.

Therefore, in the tire forming apparatus 100 according to the present embodiment, it is possible to more suitably adjust the press force F in the vicinity of the bead core where a relatively large press force is required from the viewpoint of reducing the air entering between unvulcanized tire members, or the like and in the outer zone in the radial direction of the drum spindle body 1 relative to the vicinity of the bead core where a relatively small press force is desired from the viewpoint of reducing unevenness defects on an attachment surface of the unvulcanized tire member, by the above-described compact configuration. Consequently, folding back defects of the unvulcanized tire member can be reduced by simple means.

The press force F is represented by Formula (1) below.

In Formula (1) below, N is the pushing force of the pushing means 3, F is the press force of the arm 2, L1 is the length between an end of the arm 2 on the pushing means 3 side and the center of the connecting portion 2C in the arm extending direction, L2 is the length between the line segment connecting the slidable contact portion 2A and press portion 2B and the end of the connecting portion 2C in a direction perpendicular to the arm extending direction, L3 is the length between the end of the press portion 2B of the arm 2 and the center of the connecting portion 2C in the arm extending direction, a is an inclination angle of the carcass ply 10 with respect to the axial direction of the drum spindle body 1, and θ is an inclination angle of the arm 2 (arm angle) with respect to the axial direction of the drum spindle body 1 (θ<α<90°).

$$\begin{matrix}[ Expression 1 ] & \\ F = \frac{N}{{L}_{3}} ( {L}_{2} cos θ - {L}_{1} sin θ ) cos ( \text{∝} - θ ) & Formula ( 1 )\end{matrix}$$

From Formula (1) above, it can be understood that, in the tire forming apparatus 100 according to the present embodiment, the press force F with respect to the carcass ply 10 decreases as the arm angle θ increases. Moreover, the decreasing ratio of the press force F due to an increase in the arm angle θ can be adjusted by increasing the length L1 between the end of the arm 2 on the pushing means 3 side and the center of the connecting portion 2C in the arm extending direction. That is, the longer the length L1, the greater the decreasing ratio of the press force F due to an increase in the arm angle θ.

Whereas, in the conventional tire forming apparatus 300, the arm 32 receives the biasing force T due to tension of the rubber band 35, and the biasing force T increases as the arm angle θ increases, and accordingly the press force F also increases as the arm angle θ increases. The arm 32 is moved and opened without moving the rear end portion 32B of the arm 32 in a sliding contact manner on the pushing means 33, and, therefore, when the arm angle θ of the arm 32 reaches or exceeds a certain value, the front end portion 32A of the arm 32 jumps upward in the drawing if there is no tension T of the rubber band 35, and the press force F with respect to the unvulcanized tire member 30 decreases extremely. In this case, the outside in a tire radial direction of a green tire cannot be appropriately formed.

In the tire forming apparatus 100 according to the present disclosure, the pushing force N from the pushing means 3 is directly applied to the slidable contact portion 2A of the arm 2, and the slidable contact portion 2A moves in a sliding contact manner in a tire radial direction on the pushing means 3, and therefore it is possible to apply an appropriate press force to the unvulcanized tire member 10 across the tire radial direction.

In the tire forming apparatus 100 according to the present embodiment, the arm 2 has the arm main body portion 21 that couples the slidable contact portion 2A and the press portion 2B together, and the arm branch portion 22 that couples the arm main body portion 21 and the connecting portion 2C together, and both of the arm main body portion 21 and the arm branch portion 22 extend linearly as described above, and thus the tire forming apparatus is compactly configured.

However, it is possible to arbitrarily and integrally couple the slidable contact portion 2A, the press portion 2B and the connecting portion 2C together as long as the connecting portion 2C is in between the slidable contact portion 2A and the press portion 2B in the extending direction of the arm 2 and is connected to the drum spindle body 1, on the drum spindle body 1 side with respect to the line segment connecting the slidable contact portion 2A and the press portion 2B.

For example, the slidable contact portion 2A and the press portion 2B can be coupled in a curved shape (the arm main body portion 21 is in a curved shape), the arm main body portion 21 and the connecting portion 2C can be coupled in a curved shape (the arm branch portion 22 is in a curved shape), or the slidable contact portion 2A and the press portion 2B can be integrally connected through the connecting portion 2C.

In addition, as illustrated with a tire molding apparatus 200 according to another embodiment of the present disclosure in FIG. 3, the arm 2 can also be connected indirectly to the drum spindle body 1 through other component member, for example, an arm support body 3C, arranged between the arm 2 and the drum spindle body 1.

The tire forming apparatus 200 has the same configuration as the above-described tire forming apparatus 100, except being provided with the arm support body 3C.

For example, with a ball screw (not illustrated) extending along the axial direction of the drum spindle body 1, the arm support body 3C can slide on the drum spindle body 1 along the axial direction, support the arm 2 by being interposed between the arm 2 and the drum spindle body 1, and also push the arm 2 in a direction approaching an unvulcanized tire member (the unvulcanized carcass ply 10 in the present embodiment) along the axial direction of the drum spindle body 1. In the tire forming apparatus 200, the driving portion 3A, the pushing portion 3B and the arm support body 3C constitute the pushing means 3.

Thus, in the case where the arm 2 is connected to the drum spindle body 1 through the arm support body 3C, for example, if the arm support body 3C is configured to be rotatable in a circumferential direction of the drum spindle body 1, it is possible to rotate the arm 2 in the circumferential direction of the drum spindle body 1.

Moreover, during a period from a state in which the arm 2 is distant from the carcass ply 10 until the press portion 2B of the arm 2 comes into contact with the carcass ply 10 in the vicinity of the bead core (the state illustrated in FIG. 3A) and a period when the arm 2 is moved and opened outward in the radial direction of the drum spindle body 1 while pressing the carcass ply 10 (the state illustrated in FIG. 3B), the arm 2 can be moved closer to the carcass ply 10 and pressed against the carcass ply 10 without moving the connecting portion 2C in a sliding contact manner on other component such as the drum spindle body 1.

As described above, in the tire forming apparatuses 100, 200, the press force F with respect to the unvulcanized tire member (the unvulcanized carcass ply 10 in the above-described embodiments) can be suitably increased or decreased, according to the arm angle θ, based on a constant pushing force N. Moreover, by controlling the pushing force N of the pushing means 3 itself, it is possible to more suitably increase or decrease the press force F, according to the press position of the unvulcanized carcass ply 10.

The slidable contact surface S of the slidable contact portion 2A of the arm 2 with respect to the pushing means 3 (the slidable contact surface with respect to the pushing portion 3B in the present embodiment) is preferably made of a curved surface (for example, a semi-circular curved surface) protruding toward the pushing means 3. In this case, since the slidable contact portion 2A can easily slide on the corresponding slidable contact surface S of the pushing means 3, the arm 2 can be more smoothly moved and opened.

Furthermore, if the slidable contact portion 2A of the arm 2 is formed of a rotatable roller, the slidable contact portion 2A can more easily slide on the corresponding slidable contact surface S′ of the pushing means 3 (the corresponding slidable contact surface of the pushing portion 3B in the present embodiment). In this case, the arm main body portion 21 is configured to be capable of being turned around the slidable contact portion 2A.

The slidable contact portion 2A of the arm 2 can be improved in slidability by plating or nitriding the slidable contact surface S of the slidable contact portion 2A. As the plating, for example, hard chrome plating can be used.

The press portion 2B of the arm 2 can be formed, for example, with one, two, three or more rotatable rollers.

The connecting portion 2C of the arm 2 can be formed of, for example, a rotatable roller or a hinge body. In this case, the arm branch portion 22 is configured to be capable of being turned around a central axis of the connecting portion 2C.

The corresponding slidable contact surface S′ of the pushing means 3 in the above-described embodiment (the pushing portion 3B of the pushing means 3 in the above-described embodiment) is formed to be perpendicular to the drum spindle body 1, but, for example, can be formed to be inclined with respect to the drum spindle body 1, or can be formed of a curved line connecting one, two or a plurality of circular arcs.

Thus, by inclining and/or bending the corresponding slidable contact surface S′ of the pushing portion 3B with respect to the axial direction of the drum spindle body 1, displacement of thrust due to the pushing means 3 can be adjusted.

In the case where the corresponding slidable contact surface S′ is inclined with respect to the drum spindle body 1, for example, it is advantageous to incline the corresponding slidable contact surface S′ to have an acute angle between the corresponding slidable contact surface S and the drum spindle body 1 on the pushing means 3 side in order to decrease the press force F with respect to the unvulcanized tire member (the unvulcanized carcass ply 10 in the present embodiment) according to an increase in the arm angle A.

According to a tire manufacturing method of forming a tire using the tire forming apparatus 100, 200 described above, folding back defects of an unvulcanized tire member can be reduced.

### REFERENCE SIGNS LIST

1, 31 Drum spindle body
2, 32 Arm
2A Slidable contact portion
2B Press portion
2C Connecting portion
21 Arm main body portion
22 Arm branch portion
3, 33 Pushing means
3A Driving source
3B Pushing portion
3C Arm support body
10, 30 Unvulcanized carcass ply (unvulcanized tire member)
32A Front end portion
328 Rear end portion
35 Rubber band
100, 300 Tire forming apparatus
S Slidable contact surface
S′ Corresponding slidable contact surface

1. A tire forming apparatus comprising: a drum spindle body; a plurality of arms arranged in an annular shape on an outer circumferential side of the drum spindle body; and pushing means configured to push the arms in a direction approaching an unvulcanized tire member, along an axial direction of the drum spindle body, wherein
each of the arms includes:
a slidable contact portion provided on one end side of the arm and configured to slidably contact the pushing means;
a press portion provided on an other end side of the arm and configured to come into contact with the unvulcanized tire member and press the unvulcanized tire member; and
a connecting portion provided between the slidable contact portion and the press portion in an extending direction of the arm and connected to the drum spindle body, on the drum spindle body side with respect to a line segment connecting the slidable contact portion and the press portion.

2. The tire forming apparatus according to claim 1, wherein each of the arms includes an arm main body portion that couples the slidable contact portion and the press portion together, and an arm branch portion that couples the arm main body portion and the connecting portion together.

3. The tire forming apparatus according to claim 1, wherein a slidable contact surface of the slidable contact portion with respect to the pushing means is made of a curved surface protruding toward the pushing means.

4. The tire forming apparatus according to claim 1, wherein the slidable contact portion is made of a rotatable roller.

5. A tire manufacturing method for forming a tire using the tire forming apparatus according to claim 1.

6. The tire forming apparatus according to claim 2, wherein a slidable contact surface of the slidable contact portion with respect to the pushing means is made of a curved surface protruding toward the pushing means.

7. The tire forming apparatus according to claim 2, wherein the slidable contact portion is made of a rotatable roller.

8. The tire forming apparatus according to claim 3, wherein the slidable contact portion is made of a rotatable roller.

9. A tire manufacturing method for forming a tire using the tire forming apparatus according to claim 2.

10. A tire manufacturing method for forming a tire using the tire forming apparatus according to claim 3.

11. A tire manufacturing method for forming a tire using the tire forming apparatus according to claim 4.

12. The tire forming apparatus according to claim 6, wherein the slidable contact portion is made of a rotatable roller.

13. A tire manufacturing method for forming a tire using the tire forming apparatus according to claim 6.

14. A tire manufacturing method for forming a tire using the tire forming apparatus according to claim 7.

15. A tire manufacturing method for forming a tire using the tire forming apparatus according to claim 8.
